(19) United States
(12) Patent Application Publication
(10) Pub. No.: US 2025/0368218 A1
(43) Pub. Date: Dec. 4, 2025

(54) Synchronizing Ambient Cabin Experience with Drive Mode

(71) Applicant: Nissan North America, Inc., Franklin, TN (US)

(72) Inventors: Corey Heath, Scottsdale, AZ (US); Niloofar Zarei, Campbell, CA (US); Kevin Kochever, San Bruno, CA (US); Erik Lee St. Gray, Tacoma, WA (US); Stefan Witwicki, San Carlos, CA (US); Luis Lorenzo Bill Clark, San Francisco, CA (US); Mark Bailey, Seattle, WA (US)

(21) Appl. No.: 18/680,650

(22) Filed: May 31, 2024

(51) Int. Cl. B60W 50/16; B60W 30/182; B60W 40/08; B60W 50/00; B60W 50/14

(52) U.S. Cl. CPC B60W 50/16; B60W 30/182; B60W 40/08; B60W 2050/0083; B60W 2050/143; B60W 2050/146; B60W 2540/215; B60W 2556/45

(57) ABSTRACT

System and method for determining a drive mode of a vehicle, such as an eco mode or a sport mode, and retrieving a human-machine interface (HMI) policy based on the drive mode. The HMI policy describes output parameters of various HMI systems of the vehicle, such as an audio system or a haptic system. The system and method further includes causing an HMI system of the vehicle to implement the HMI policy, where such implementation includes generating outputs, such as sounds, lighting patterns, and haptic vibrations, according to the output parameters described by the HMI policy. The system and method may optionally include retrieving a driver profile for a driver of the vehicle, such that the retrieved HMI policy is also based on the driver profile.

### TECHNICAL FIELD

This disclosure relates generally to an intelligent powertrain system (IPT) for a vehicle, and more particularly, to communicating one or more drive modes established by the IPT system to a driver of the vehicle via one or more human-machine interfaces (HMIs).

### BACKGROUND

An IPT system configures vehicle mode and engine optimizations of a vehicle based on, for example, vehicle information (i.e., sensor information and/or route information). The terms “drive mode,” “driving mode,” “IPT mode,” and “powertrain mode” may be used interchangeably herein to include both a vehicle mode and engine optimizations.

Some examples of drive modes known in the art, and which may be referred to by various de facto and/or trade names, include “eco mode” (economizes fuel consumption or stored battery energy while driving); “sport mode” (provides more responsive throttle, increased power availability, stiffer suspension, and/or firmer steering); “snow mode” (alters a vehicle's driving dynamics to achieve better control and grip on a driving surface); “off-road mode” (maximizes a vehicle's traction); “4-wheel drive (4WD) mode,” “2-wheel drive (2WD) mode,” “all-wheel drive (AWD) mode,” and “front-wheel drive (FWD) mode” (provides certain wheels of a vehicle with certain power at specific times and/or under specific conditions); “cruise mode” or “cruise control” (maintains constant vehicle speed); “engine on/off mode” (turns on an engine of a vehicle to charge a battery of the vehicle or turns off the engine such that the vehicle is thereafter propelled by power from the battery); “e-pedal mode” (controls acceleration, deceleration, and stopping using a single pedal of a vehicle); “low regenerative braking mode” (e.g., Nissan's “D mode,” which provides standard or balanced driving performance); and “high regenerative braking mode” (e.g., Nissan's “B mode,” which provides increased regenerative braking).

Some examples of sensor information and/or route information known in the art include state-of-charge (SoC) of a battery, engine state, vehicle velocity and/or acceleration, vehicle pose (e.g., yaw, pitch, and roll), vehicle elevation, global navigation satellite system (GNSS) position, route destination, road terrain, road conditions, weather conditions, and so on.

Some examples of determining, modifying, and/or utilizing various drive modes are described in the following patent references, all of which are incorporated herein by reference. U.S. Pat. No. 11,608,048, entitled “Intelligent Engine Activation Planner,” discloses a system that plans and activates engine actions for vehicle segments based on a model incorporating a navigation map, current battery charge level, and engine state, and selects from the actions to either turn on the engine to charge the battery or turn the engine off. U.S. Pat. No. 11,614,335, entitled “Route Planner Optimization for Hybrid-Electric Vehicles,” discloses a system for planning a route for a hybrid electric vehicle (HEV), where the route is optimized for at least one of a noise level or energy consumption of an engine of the HEV that is used to charge a battery of the HEV and where the route comprises respective engine activation actions for at least some segments of the route, and the system further controls the HEV to follow the segments of the route and to activate the engine according to the respective engine activation actions. U.S. Pat. No. 11,946,760, entitled “Navigation Map Learning for Intelligent Hybrid-Electric Vehicle Planning,” discloses a system for activating an engine of an HEV to charge its battery by aggregating global positioning system (GPS) traces from multiple trips to update a navigation map, selecting an engine activation action (either turning the engine on or off) based on the map, and executing the action, where activating the engine using the first activation action causes the engine to turn on to charge the battery of the HEV. U.S. patent application Ser. No. 18/651,430, entitled “Intelligent Eco Mode Optimization for Battery Electric Vehicles,” discloses a system for a battery electric vehicle (BEV) that involves collecting data from the vehicle's systems to determine the vehicle's state and to generate a predicted route, and determining a drive mode of the vehicle using a decision-making model based on the state and the predicted route.

### SUMMARY

Disclosed herein are aspects, features, elements, implementations, and embodiments of a method, a system, and a non-transitory computer-readable medium for synchronizing an ambient cabin experience with one or more drive modes that may be established and/or modified by an IPT system.

A first aspect of the disclosed implementations is a method for communicating a drive mode of a vehicle to a driver of the vehicle via an HMI. The method includes determining a drive mode of a vehicle, retrieving an HMI policy based on the drive mode, and causing an HMI system of the vehicle to implement the HMI policy. The terms “HMI” and “HMI system” may used interchangeably herein to describe a system, apparatus, device, or component that implements a human-machine interface. An HMI policy is a set of indications and/or instructions that describes or specifies output parameters of an HMI system for a given drive mode or a given change in a drive mode.

A second aspect of the disclosed implementations is a system for communicating a drive mode of a vehicle to a driver of the vehicle via an HMI. The system includes one or more memories and one or more processors configured to execute instructions stored in the one or more memories to determine a drive mode of a vehicle, retrieve an HMI policy based on the drive mode; and cause an HMI system of the vehicle to implement the HMI policy.

A third aspect of the disclosed implementations is a non-transitory computer-readable medium storing instructions operable to cause one or more processors to perform operations. The operations comprise determining a drive mode of a vehicle, retrieving an HMI policy based on the drive mode; and causing an HMI system of the vehicle to implement the HMI policy.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for communicating a drive mode established by an IPT system of a vehicle to a driver of the vehicle via an HMI.

FIG. 5 is a flowchart of an example of a process for communicating a drive mode of a vehicle to a driver of the vehicle via an HMI.

FIG. 6 is a flowchart of another example of a process for communicating a drive mode of a vehicle to a driver of the vehicle via an HMI.

### DETAILED DESCRIPTION

To describe some implementations in greater detail, reference is made to the following figures.

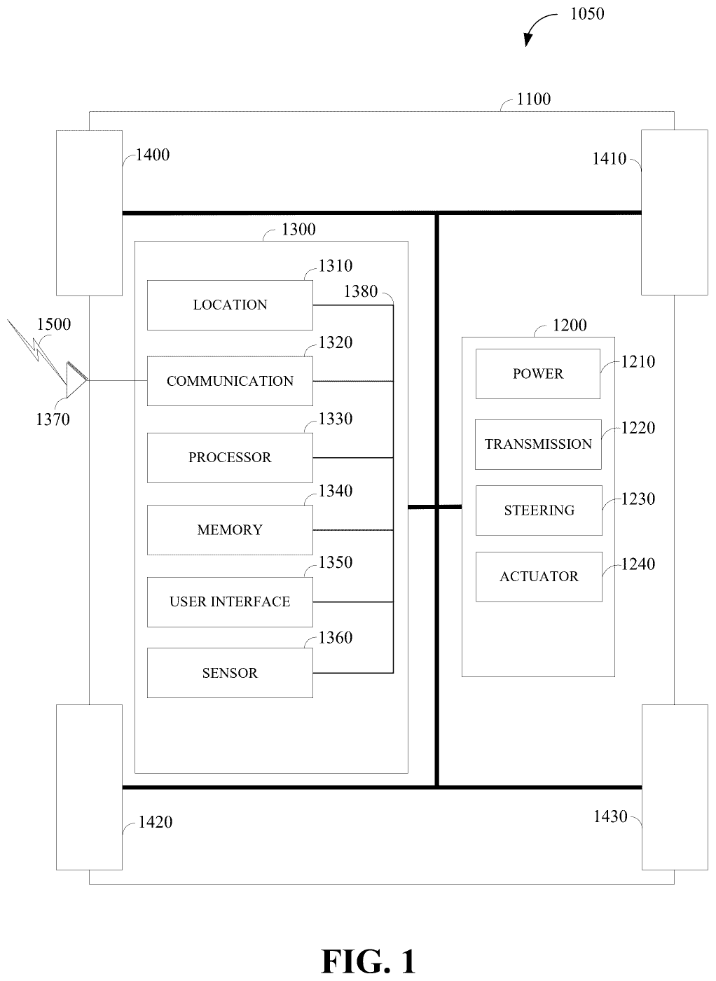

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment surrounding the vehicle 1050. For example, one or more sensors detect road geometry and obstacles, such as fixed obstacles, vehicles, cyclists, and pedestrians. In some embodiments, the sensor 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

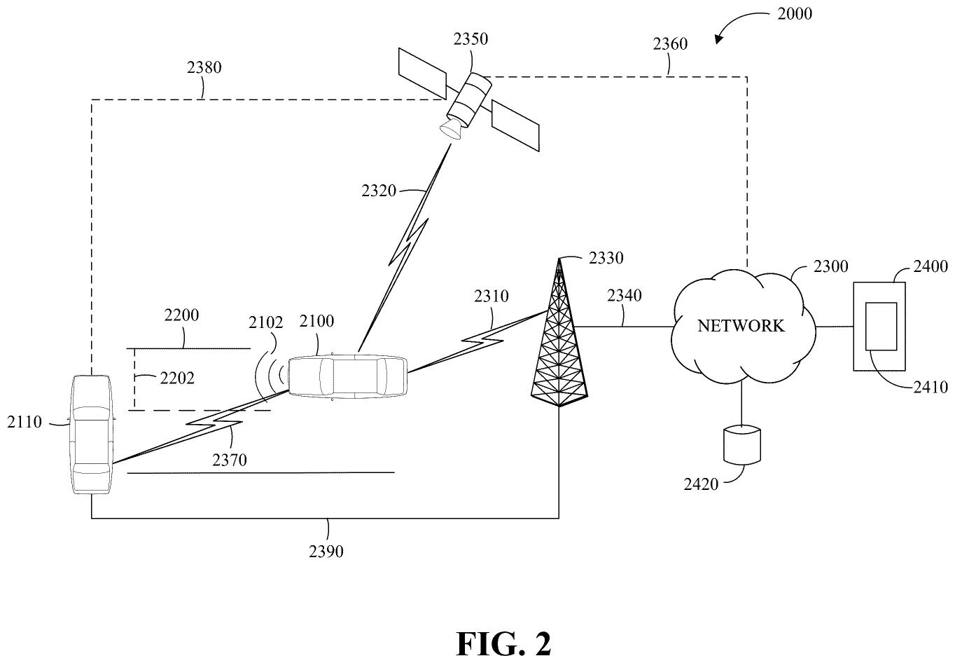

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

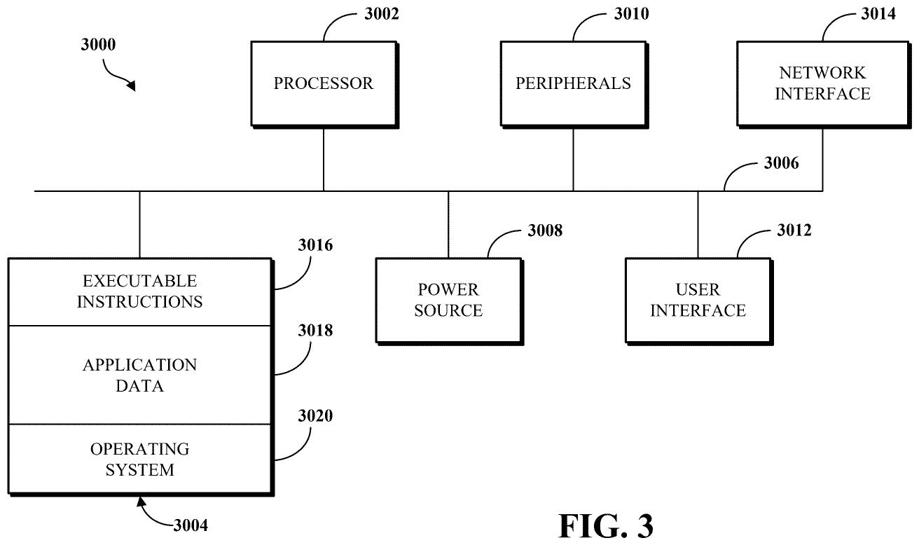

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

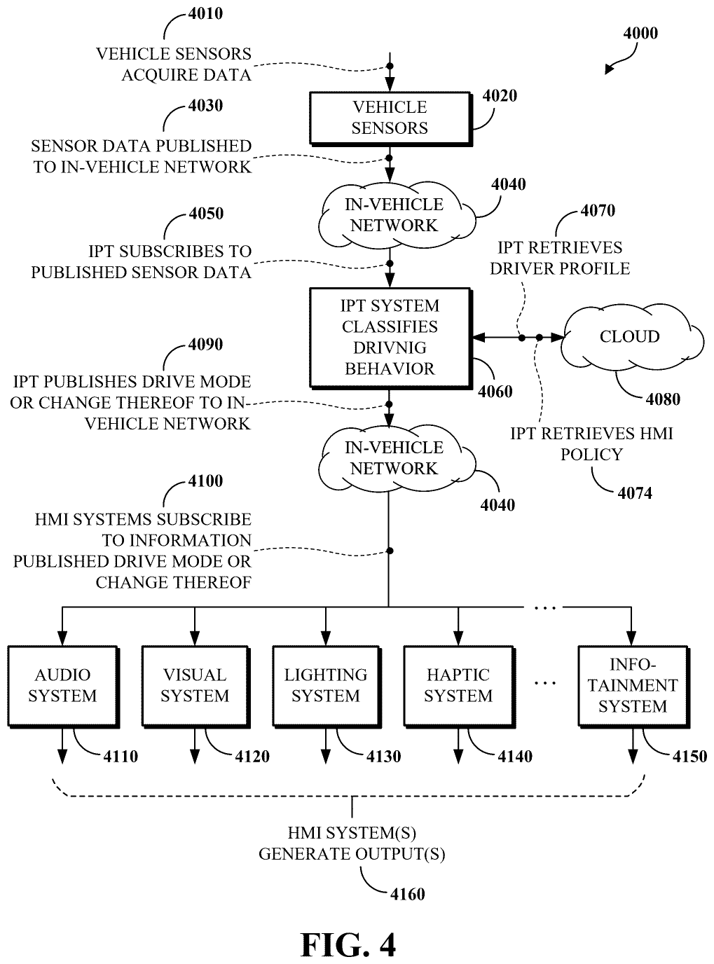

FIG. 4 is a diagram of an example of a system 4000 for communicating a drive mode established by an IPT system of a vehicle to a driver of the vehicle via an HMI. In a process 4010, one or more vehicle sensors 4020 acquire sensor data. Vehicle sensors 4020 may include an inertial measurement unit (IMU) (for measuring, e.g., acceleration, angular velocity, yaw, pitch, and roll), a mass airflow sensor, an oxygen sensor, an engine speed sensor, an oil pressure sensor, a voltage sensor, a tire-pressure sensor, a rain/precipitation sensor, an air-intake sensor, a camshaft position sensor, a throttle position sensor, a knock sensor, a fuel temperature sensor, a battery temperature sensor, a GNSS sensor (e.g., a GPS sensor), video (e.g., optical, infrared), lidar, radar, sonar, and others. Each sensor may be, for example, the sensor 1360 of FIG. 1.

In a process 4030, at least some of the sensor data, (e.g., raw, preprocessed, or processed data) is published to an in-vehicle network 4040, such as a controller area network (CAN) bus. The in-vehicle network 4040 may include, for example, the communication bus 1380 of FIG. 1. The sensor data may be published by one or more individual vehicle sensors 4020 and/or by one or more electronic control units (ECUs) that are communicatively coupled to one or more sensors. An ECU may be, for example, the controller 1300 of FIG. 1. Publishing of sensor data may include storing sensor data in a memory, such as the memory 1340 of FIG. 1. Publishing of data or information may include broadcasting, multicasting, narrowcasting, or unicasting the data or information. Publishing of data or information by a first system (e.g., a server) is sometimes called a “push notification” to a second system (e.g., a client). This contrasts with a “pull notification,” which involves the second system (e.g., client) querying the first system (e.g., server) for any updates to some relevant data or information.

In a process 4050, an IPT system subscribes to the published sensor data and thereby receives the sensor data. Based at least on the published sensor data, the IPT system performs a process 4060 of classifying the driving behavior indicated by one or more of the sensors and determining a corresponding drive mode that is appropriate for the driving behavior. For example, if a precipitation sensor detects precipitation, a temperature sensor detects freezing temperatures, and a wheel-traction sensor detects wheel slippage, the IPT system may determine that an appropriate drive mode is snow mode. As another example, if a GPS sensor detect a route from home to a workplace during a typical (e.g., previously observed) morning commute time and an IMU sensor detects mostly gentle vehicle accelerations, the IPT system may determine that appropriate drive mode is eco mode.

In some implementations, the publish-subscribe process described herein may utilize a Robot Operating System (ROS) publish-subscribe framework. Alternatively or additionally, other processes may be utilized to communicate information from a first system to a second system, such as event-driven programming and web-based application programming interfaces (APIs).

In some implementations, the IPT system may immediately or quickly publish the newly determined drive mode contemporaneously with the IPT system's effectuating of the drive mode. In other implementations, the system IPT may delay its effectuating of the newly determined drive mode and the IPT system may accordingly publish a “next” or “upcoming” drive mode and a time at which (or a delay after which) the newly determined drive mode will take effect. Both of these implementations may be included in the process 4090 where the IPT system publishes the drive mode or a change in the drive mode to the in-vehicle network 4040.

In a process 4070, the IPT system retrieves a driver profile from cloud storage 4080. The driver profile comprises information about the driver of the vehicle (and possibly about other occupants) that the IPT system can use to determine a personalized or driver-specific HMI policy for implementation by one or more HMI systems, as described in more detail below. A person (e.g., driver or occupant) may be identified by a suitable manner, such as by a specific key or fob used to start the vehicle; by the driver authenticating to the vehicle by entering a username and/or password (such as by typing, by speech-to-text, and so on); by a proximity between a specific mobile device of the driver (such as a smart phone or a smart watch) and the vehicle; by voice recognition of audio captured by a microphone; by image recognition captured by a video camera; and so on. In some implementations, some or all of the driver profile may be retrieved from local storage, such the memory 1340 of FIG. 1. In some implementations, the driver profile is not retrieved, and the HMI policy may therefore not be personalized to a particular driver.

In a process 4074, the IPT system retrieves an HMI policy (or multiple HMI policies, such as one HMI policy per HMI system) from cloud storage 4080. The HMI policy comprises information about the outputs of the one or more HMI systems, including, for example, types of outputs, intensities, volumes, durations, timings, repetitions, variations, and so on, for synchronizing the ambient cabin experience with the drive mode. For example, an HMI policy for a lighting system, such as the lighting system 4130 of FIG. 4 that will be discussed further below, may comprise information that details which ambient cabin light-emitting diodes (LEDs) to turn on and for how long, and what color and intensity they should output. In some implementations, the HMI policy is published to the in-vehicle network 4040 along with the drive mode or a scheduled (e.g., upcoming) change in the drive mode, for example, as a push notification to subscribed HMI systems. In other implementations, the HMI policy is retrieved by an appropriate HMI system in response to the HMI system receiving new drive-mode information from the IPT system, for example, as a pull notification. In some implementations, some or all of the HMI policy is retrieved from local storage, such as the memory 1340 of FIG. 1.

In a process 4100, one or more HMI systems subscribe to the published drive-mode information and thereby receives the published drive-mode information. The one or more HMI systems also receive, or retrieve, one or more HMI policies. Examples of HMI systems include an audio system 4110 (such as cabin speakers), a visual system 4120 (such as a dashboard graphical display), a lighting system 4130 (such as cabin lighting), a haptic system 4140 (such as seat or steering wheel vibrators), and an infotainment system 4150 (such as a system that delivers information and/or entertainment to occupants of the vehicle through various discrete and/or coordinated multimedia). The one or more HMI systems generate outputs 4160 based on the HMI policy. Several examples of outputs implemented by various HMI systems for synchronizing the ambient cabin experience with various drive modes are described below. These examples are merely representative and are not exhaustive.

Eco mode: Eco-mode economizes fuel consumption or stored battery energy while driving. When the vehicle enters eco mode, various LEDs of the lighting system 4130 may glow a green color, where green commonly represents reduced consumption or fuel or energy. Additionally, the audio system 4110 may play a soothing or muted notification sound when the vehicle first enters eco mode, and the infotainment system 4150, in collaboration with the audio system 4110, may begin selecting and playing songs or tracks from playlists or genres that have been determined to be representative of eco mode. Such playlists or genres may have been determined, for example, manually by the driver, by crowdsourced decision-making, or by machine-learning algorithms.

Sport mode: Sport mode provides more responsive throttle, increased power availability, stiffer suspension, and/or firmer steering. When the vehicle enters sport mode, various LEDs of the lighting system 4130 may glow a red color, where red commonly represents high activity or alertness. Additionally, the haptic system 4140 may vibrate the driver's seat when the vehicle first enters sport mode, and the haptic system 4140 may vibrate the steering wheel whenever the vehicle enters a turn that causes a lateral g-force in excess or a predefined amount. Additionally, the infotainment system 4150, in collaboration with the visual system 4120, may show and/or emphasize certain vehicle performance metrics on the dashboard display, such as engine RPMs and vehicle velocity or acceleration.

Snow mode, off-road mode, 4WD mode, or AWD mode: While there may be differences between snow mode, off-road mode, 4WD mode, and AWD mode, each of these modes generally alters a vehicle's driving dynamics and wheel traction to achieve better control and grip on a driving surface. When the vehicle enters one of these modes, for example, snow mode, various LEDs of the lighting system 4130 may glow white or blue color to mimic the color of snow or ice. Additionally, the infotainment system 4150, in collaboration with the visual system 4120, may show and/or emphasize certain indicators on the dashboard display, such as wheel traction or exterior temperature.

B mode: B mode provides increased regenerative braking, which is when the kinetic energy from braking is captured and stored (e.g., as electrical energy in a batter) for later use by the vehicle. When the vehicle is operating in B mode, various LEDs of the lighting system 4130 may glow a certain color or with a certain intensity in proportion to an instantaneous amount of kinetic energy that is being captured during a regenerative braking event. Similarly, various LEDs of the lighting system 4130 may glow a different color when such captured energy is being used to propel the vehicle. Additionally, the infotainment system 4150, in collaboration with the visual system 4120, may show and/or emphasize an eco-indicator bar that shows how much energy has been captured or saved as a result of regenerative braking.

In some implementations, the HMI policy associated with a given drive mode and/or with a given HMI system may be configurable. One method of configuring an HMI policy is by manual modification of selected output parameters of a selected HMI system via a graphical user interface (GUI) on a computer, smartphone, tablet, infotainment system, or other computing device, which may be an instance of the computing device 3000 of FIG. 3. Output parameters may include, for example, audio sounds, speaker volumes, speaker locations, and patterns; visual graphics; lighting colors, intensities, zones, and patterns; haptic intensities and zones, and patterns; multimedia files, tracks, lists, and libraries; and so on. For example, to configure an ambient cabin lighting HMI policy, a configuration GUI may present a plan view of an interior of a vehicle that indicates the locations of various LEDs that the user can select and modify. As an example, the user could group LEDs together to behave similarly or ungroup LEDs so they may behave independently. As another example, the user could configure LED color, intensity, flash pattern, activation duration, and so on, where the GUI may present a color wheel or color palette to the user for configuring color selection, a slider bar for configuring intensity, a duty-cycle waveform for configuring flash patterns, and a text-entry box for entering a time value for configuring activation duration.

Another method of configuring an HMI policy is by implicit or explicit modification via a graphical user interface (GUI) presented by the vehicle to the user, such as the driver, while the vehicle is in a particular drive mode. When the vehicle is the particular drive mode, the driver may implicitly make certain adjustments to the output parameters of the HMI systems, such as turning up the volume of the speakers, dimming the cabin lighting, and so on. An ECU or other processing device of the vehicle may record such adjustments, and over time, if the driver frequently makes the same or similar adjustments, the adjusted output parameters of the HMI systems will replace the less preferred output parameters in the HMI policy. The adjustments may be achieved by a suitable manner, such as the user pressing buttons or turning knobs, utilizing a touchscreen, speaking aloud to a voice assistant, and so on. Additionally, when the vehicle is in the particular drive mode, the driver may explicitly instruct the GUI to modify certain output parameters of the HMI systems, such as by speaking commands to a speech-to-text system like “play songs from my ‘greatest hits’ playlist whenever I'm in this driving mode.”

Similarly, the driver could force an association between a current or particular drive mode and a current or particular state of the vehicle (e.g., sensor information and/or route information). As an example, the driver could say to a speech-to-text system of the vehicle, “go into eco mode whenever I'm commuting to work.” The system would determine the route or routes from home to work and the days and times during which such route or routes are traveled by the driver and would thereafter put the vehicle in eco mode when those conditions are met. As another example, the driver could say to the speech-to-text system of the vehicle, “use this mode when I'm driving on a dirt road.” The system would determine the current drive mode, and would thereafter put the vehicle in that drive mode when the system determines, based on map data and/or sensor data, that the vehicle is driving on a dirt road.

Another method of configuring an HMI policy is by machine learning via a system that observes adjustments that a user, such as a driver, makes to the HMI systems while the vehicle is in a given drive mode, such as turning up the volume of the speakers, dimming the cabin lighting, and so on. Over time, the machine-learning system learns the driver's preferences for the ambient cabins experience while in various drive modes, and creates or modifies one or more HMI policies accordingly, so that the next time the vehicle enters a particular drive mode, the HMI systems implement the learned HMI policy or policies.

In some implementations, third-party applications or services may be utilized to achieve an HMI policy. For example, an ECU or other processing device of a vehicle could interface with a streaming music service for selection of appropriate music to play during a given drive mode. In some implementations, the third-party streaming music service may select music only from user-curated playlists. In other implementations, the third-party streaming music service may select music from specific channels or genres based on manual or crowdsourced curation or by machine learning.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The techniques 5000 and 6000 described below are techniques for synchronizing the ambient cabin experience with the drive mode of a vehicle. These techniques may be implemented by an ECU and/or a processor in the vehicle, such as the processor 1330 of FIG. 1, as well as by computing devices external to the vehicle, such as at least one computing apparatus 2410 of the data-processing center 2400 of FIG. 2 and/or one or more mobile computing devices, such as smartphones, smart watches, and tablets.

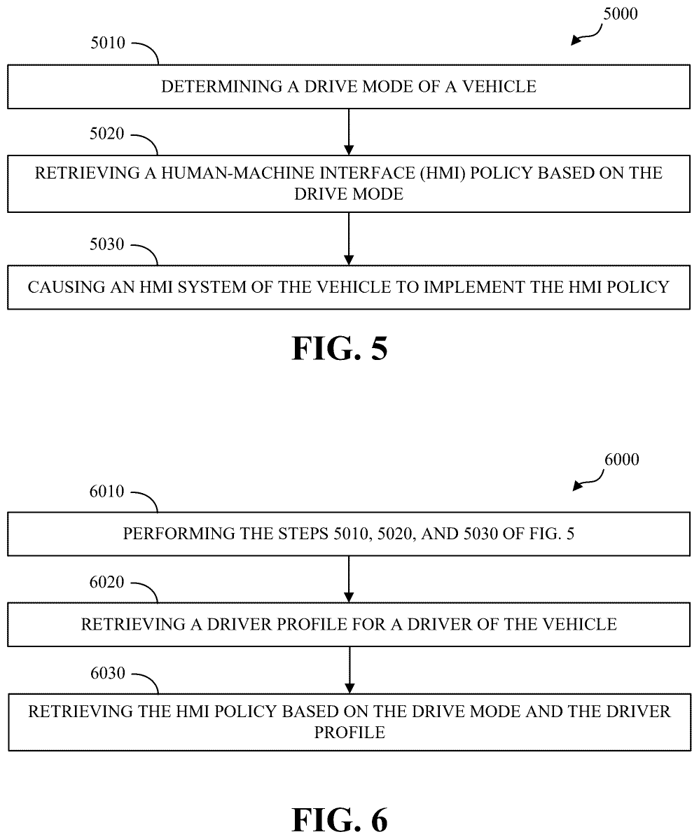

FIG. 5 is a flowchart of an example of a technique 5000 for synchronizing the ambient cabin experience with the drive mode of a vehicle.

The step 5010 comprises determining a drive mode of a vehicle. The vehicle may be the vehicle 1050 of FIG. 1. In some implementations, determining the drive mode based on information received from an IPT system, wherein the IPT system utilizes at least one of sensor information and route information to establish the drive mode. In some implementations, the drive mode is at least one of: eco mode; sport mode; snow mode; off-road mode; 2-wheel drive; 4-wheel drive; all-wheel drive; front-wheel drive; engine on/off mode; e-pedal mode; low regenerative braking mode; or high regenerative braking mode.

The step 5020 comprises retrieving an HMI policy based on the drive mode. In some implementations, some or all of the HMI policy is retrieved from a cloud storage, such as the cloud storage 4080 of FIG. 4. In some implementations, some or all of the HMI policy is retrieved from a storage local to the vehicle, such as the memory 1340 of FIG. 1. In some implementations, the steps further comprise: causing a graphical user interface to prompt a user to select from the HMI policy and a second HMI policy; and receiving user input selecting the HMI policy. In some implementations, the steps further comprise: receiving user input indicating one or more customizations to the HMI policy; associating a resulting customized HMI policy with the drive mode; and storing the customized HMI policy for later retrieval based on the drive mode. In some implementations, the steps further comprise: detecting a presence of a passenger in the vehicle based on one or more in-vehicle sensors; and retrieving the HMI policy based on the drive mode and the presence of the passenger.

The step 5030 comprises causing an HMI system of the vehicle to implement the HMI policy. In some implementations, the HMI system includes an audio system, such as the audio system 4110 of FIG. 4; and the HMI policy includes at least one of: playing a sound alert; or playing a song from a predefined genre or from a predefined playlist. In some implementations, the HMI system includes a lighting system, such as the lighting system 4130 of FIG. 4; and the HMI policy includes activating one or more in-cabin lights according to at least one of a predefined activation pattern, a predefined color, a predefined intensity, a predefined duration, or a predefined location within the vehicle. In some implementations, the HMI system includes a haptic system, such as the haptic system 4140 of FIG. 4; and the HMI policy includes activating one or more haptic devices according to at least one of a predefined activation pattern, a predefined intensity, a predefined duration, or a predefined location within the vehicle. In some implementations, the HMI system includes a display system, such as the visual system 4120 of FIG. 4; and the HMI policy includes displaying at least one of a predefined visual alert or a predefined contextual graphical user interface. In some implementations, the HMI system includes an audio system, such as the audio system 4110, and the HMI policy includes playing a song from a predefined genre or from a predefined playlist, the method further comprising: retrieving the song from a third-party music-streaming service.

FIG. 6 is a flowchart of an example of a technique 6000 for synchronizing the ambient cabin experience with the drive mode of a vehicle.

The step 6010 comprises performing the steps 5010, 5020, and 5030 of FIG. 5.

The step 6020 comprises retrieving a driver profile for a driver of the vehicle. In some implementations, some or all of the driver profile is retrieved from a cloud storage, such as the cloud storage 4080 of FIG. 4. In some implementations, some or all of the driver profile is retrieved from a storage local to the vehicle, such as the memory 1340 of FIG. 1.

The step 6030 comprises retrieving the HMI policy based on the drive mode and the driver profile.

The above-described techniques can be implemented as a method, a system, and a non-transitory computer-readable medium, for example, as described below.

In an example implementation as a method, the method, to be executed by a computing device, comprises: determining a drive mode of a vehicle; retrieving a human-machine interface (HMI) policy based on the drive mode; and causing an HMI system of the vehicle to implement the HMI policy.

In some implementations, the method further comprises: retrieving a driver profile for a driver of the vehicle; and retrieving the HMI policy based on the drive mode and the driver profile.

In some implementations, the method further comprises: determining the drive mode based on information received from an intelligent powertrain (IPT) system, wherein the IPT system utilizes at least one of sensor information and route information to establish the drive mode.

In some implementations, the HMI system includes at least one of: an audio system; a lighting system; a display system; or a haptic system.

In some implementations, the HMI system includes an audio system; and the HMI policy includes at least one of: playing a sound alert; or playing a song from a predefined genre or from a predefined playlist.

In some implementations, the HMI system includes a lighting system; and the HMI policy includes activating one or more in-cabin lights according to at least one of a predefined activation pattern, a predefined color, a predefined intensity, a predefined duration, or a predefined location within the vehicle.

In some implementations, the HMI system includes a haptic system; and the HMI policy includes activating one or more haptic devices according to at least one of a predefined activation pattern, a predefined intensity, a predefined duration, or a predefined location within the vehicle.

In some implementations, the HMI system includes a display system; and the HMI policy includes displaying at least one of a predefined visual alert or a predefined contextual graphical user interface.

In some implementations, the method further comprises: causing a graphical user interface to prompt a user to select from the HMI policy and a second HMI policy; and receiving user input selecting the HMI policy.

In some implementations, the method further comprises: retrieving the HMI policy from a cloud system.

In some implementations, the method further comprises: receiving user input indicating one or more customizations to the HMI policy; associating a resulting customized HMI policy with the drive mode; and storing the customized HMI policy for later retrieval based on the drive mode.

In some implementations, the method further comprises: detecting a presence of a passenger in the vehicle based on one or more in-vehicle sensors; and retrieving the HMI policy based on the drive mode and the presence of the passenger.

In some implementations, the HMI system includes an audio system and the HMI policy includes playing a song from a predefined genre or from a predefined playlist, the method further comprising: retrieving the song from a third-party music-streaming service.

In some implementations, the drive mode is at least one of: eco mode; sport mode; snow mode; off-road mode; 2-wheel drive; 4-wheel drive; all-wheel drive; front-wheel drive; engine on/off mode; e-pedal mode; low regenerative braking mode; or high regenerative braking mode.

In another example implementation as a system, the system comprises one or more memories; and one or more processors configured to execute instructions stored in the one or more memories to: determine a drive mode of a vehicle; retrieve a human-machine interface (HMI) policy based on the drive mode; and cause an HMI system of the vehicle to implement the HMI policy

In some implementations, the instructions include instructions to: determine the drive mode based on information received from an intelligent powertrain (IPT) system, wherein the IPT system utilizes at least one of sensor information and route information to establish the drive mode; retrieve a driver profile for a driver of the vehicle; and retrieve the HMI policy based on the drive mode and the driver profile.

In some implementations, the instructions include instructions to: cause a graphical user interface to prompt a user to select from the HMI policy and a second HMI policy; receive user input selecting the second HMI policy; reassociate the drive mode with the second HMI policy for later retrieval of the second HMI policy based on the drive mode; and cause the HMI system of the vehicle to implement the second HMI policy.

In another example implementation as a non-transitory computer-readable medium, the non-transitory computer-readable medium stores instructions operable to cause one or more processors to perform operations comprising: determining a drive mode of a vehicle; retrieving a human-machine interface (HMI) policy based on the drive mode; and causing an HMI system of the vehicle to implement the HMI policy.

In some implementations, the operations further comprise: causing a graphical user interface to prompt a user to select from the HMI policy and a second HMI policy; receiving user input selecting one of the HMI policy or the second HMI policy; and training a machine-learning model, for determining an optimal HMI policy based on the drive mode, with the user input.

In some implementations, the operations further comprise: retrieving a driver profile for a driver of the vehicle; and retrieving the HMI policy based on the drive mode and the driver profile; wherein the HMI system includes at least one of: an audio system; a lighting system; a display system; or a haptic system.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
determining a drive mode of a vehicle;
retrieving a human-machine interface (HMI) policy based on the drive mode; and
causing an HMI system of the vehicle to implement the HMI policy.

2. The method of claim 1, further comprising:
retrieving a driver profile for a driver of the vehicle; and
retrieving the HMI policy based on the drive mode and the driver profile.

3. The method of claim 1, further comprising:
determining the drive mode based on information received from an intelligent powertrain (IPT) system, wherein the IPT system utilizes at least one of sensor information and route information to establish the drive mode.

4. The method of claim 1, wherein the HMI system includes at least one of:
an audio system;
a lighting system;
a display system; or
a haptic system.

5. The method of claim 1, wherein:
the HMI system includes an audio system; and
the HMI policy includes at least one of:
playing a sound alert; or
playing a song from a predefined genre or from a predefined playlist.

6. The method of claim 1, wherein:
the HMI system includes a lighting system; and
the HMI policy includes activating one or more in-cabin lights according to at least one of a predefined activation pattern, a predefined color, a predefined intensity, a predefined duration, or a predefined location within the vehicle.

7. The method of claim 1, wherein:
the HMI system includes a haptic system; and
the HMI policy includes activating one or more haptic devices according to at least one of a predefined activation pattern, a predefined intensity, a predefined duration, or a predefined location within the vehicle.

8. The method of claim 1, wherein:
the HMI system includes a display system; and
the HMI policy includes displaying at least one of a predefined visual alert or a predefined contextual graphical user interface.

9. The method of claim 1, further comprising:
causing a graphical user interface to prompt a user to select from the HMI policy and a second HMI policy; and
receiving user input selecting the HMI policy.

10. The method of claim 1, further comprising:
retrieving the HMI policy from a cloud system.

11. The method of claim 1, further comprising:
receiving user input indicating one or more customizations to the HMI policy;
associating a resulting customized HMI policy with the drive mode; and
storing the customized HMI policy for later retrieval based on the drive mode.

12. The method of claim 1, further comprising:
detecting a presence of a passenger in the vehicle based on one or more in-vehicle sensors; and
retrieving the HMI policy based on the drive mode and the presence of the passenger.

13. The method of claim 1, wherein the HMI system includes an audio system and the HMI policy includes playing a song from a predefined genre or from a predefined playlist, the method further comprising:
retrieving the song from a third-party music-streaming service.

14. The method of claim 1, wherein the drive mode is at least one of:
eco mode;
sport mode;
snow mode;
off-road mode;
2-wheel drive;
4-wheel drive;
all-wheel drive;
front-wheel drive;
engine on/off mode;
e-pedal mode;
low regenerative braking mode; or
high regenerative braking mode.

15. A system, comprising:
one or more memories; and
one or more processors configured to execute instructions stored in the one or more memories to:
determine a drive mode of a vehicle;
retrieve a human-machine interface (HMI) policy based on the drive mode; and
cause an HMI system of the vehicle to implement the HMI policy.

16. The system of claim 15, wherein the instructions include instructions to:
determine the drive mode based on information received from an intelligent powertrain (IPT) system, wherein the IPT system utilizes at least one of sensor information and route information to establish the drive mode;
retrieve a driver profile for a driver of the vehicle; and
retrieve the HMI policy based on the drive mode and the driver profile.

17. The system of claim 15, wherein the instructions include instructions to:
cause a graphical user interface to prompt a user to select from the HMI policy and a second HMI policy;
receive user input selecting the second HMI policy;
reassociate the drive mode with the second HMI policy for later retrieval of the second HMI policy based on the drive mode; and
cause the HMI system of the vehicle to implement the second HMI policy.

18. A non-transitory computer-readable medium storing instructions operable to cause one or more processors to perform operations comprising:
determining a drive mode of a vehicle;
retrieving a human-machine interface (HMI) policy based on the drive mode; and
causing an HMI system of the vehicle to implement the HMI policy.

19. The medium of claim 18, the operations further comprising:
causing a graphical user interface to prompt a user to select from the HMI policy and a second HMI policy;
receiving user input selecting one of the HMI policy or the second HMI policy; and
training a machine-learning model, for determining an optimal HMI policy based on the drive mode, with the user input.

20. The medium of claim 18, the operations further comprising:
retrieving a driver profile for a driver of the vehicle; and
retrieving the HMI policy based on the drive mode and the driver profile; wherein
the HMI system includes at least one of:
an audio system;
a lighting system;
a display system; or
a haptic system.
